(19) United States
(12) Patent Application Publication
(10) Pub. No.: US 2015/0075221 A1
(43) Pub. Date: Mar. 19, 2015

(54) METHOD FOR CUTTING TOUGHENED GLASS PLATE

(71) Applicants: HAMAMATSU PHOTONICS K.K., Hamamatsu-shi (JP); Asahi Glass Company, Limited, Chiyoda-ku (JP)

(72) Inventors: Daisuke KAWAGUCHI, Shizuoka (JP); Ikuo NAGASAWA, Tokyo (JP)

(73) Assignees: HAMAMATSU PHOTONICS K.K., Hamamatsu-shi (JP); Asahi Glass Company, Limited, Chiyoda-ku (JP)

(21) Appl. No.: 14/554,502

(22) Filed: Nov. 26, 2014

Related U.S. Application Data
(63) Continuation of application No. PCT/JP2013/064394, filed on May 23, 2013.

(30) Foreign Application Priority Data
May 29, 2012 (JP) 2012-124508

(51) Int. Cl. B23K 26/00; C03B 33/02

(52) U.S. Cl. CPC B23K 26/0057; C03B 33/0222
USPC 65/60.1; 65/112

(57) ABSTRACT

A method for cutting a strengthened glass sheet according to a first embodiment of the present invention includes: a step of collecting and scanning laser light in an intermediate layer, thereby forming a first reformed region along a first cutting-scheduled line; and a step of applying an external force to propagate a crack from the first reformed region as a start point in a thickness direction of the strengthened glass sheet, thereby dividing the strengthened glass sheet. In the step of forming the first reformed region, a width d1 (mm) of the first reformed region in the thickness direction is set to d1<2×10³×K_{c}²/{π×(CT)²} based on a fracture toughness K_{c} (MPa·√m) of the strengthened glass sheet and the tensile stress CT (MPa) remaining in the intermediate layer.

### TECHNICAL FIELD

The present invention relates to a method for cutting a strengthened glass sheet, and particularly to a method for cutting a strengthened glass sheet using internal reforming through laser light.

### BACKGROUND ART

In a portable device such as a mobile phone or a personal data assistance (PDA), a glass sheet is used as a cover or substrate of a display. In response to the demand for thickness reduction and weight reduction of the portable device, a strengthened glass sheet having high strength has been used as the glass sheet in order to reduce the thickness and weight. The strengthened glass sheet includes a front surface layer in which a compressive stress remains and a back surface layer in which a compressive stress remains, and an intermediate layer formed between the front surface layer and the back surface layer in which a tensile stress remains.

Generally, the strengthened glass sheet is cut by mechanically forming a scribe line on the main surface using a hard roller or chip such as diamond, and applying a bending force along the scribe line. In the above-described method, the formation of the scribe line leads to the generation of a number of fine cracks on the cut edge surface of the strengthened glass sheet. As a result, there has been a problem of insufficient strength at a cut edge portion (so-called edge strength) in spite of the use of the strengthened glass sheet.

Patent Documents 1 and 2 disclose a method in which laser light having a wavelength that penetrates a semiconductor substrate or glass substrate is collected inside the substrate, a reformed region (internal crack) is formed inside the substrate, and the crack is propagated in the sheet thickness direction from the reformed region as a start point, thereby cutting the substrate. In this cutting method, the surface of an object to be cut is not scratched, and the reformed region is formed only inside the object to be cut (hereinafter, referred to as internal reforming-type cutting). In the internal reforming-type cutting, it is not required to form a scribe line on the main surface of a substrate, and therefore the above-described fine cracks are not generated at the cut edge surface, and the edge strength is improved. Patent Document 3 discloses a method for cutting a strengthened glass using the internal reforming-type cutting in which the reformed region is formed in an intermediate layer in which a tensile stress remains.

### CITATION LIST

### Patent Documents

Patent Document 1: JP 2003-1458 A

Patent Document 2: WO 2009/020004 A1

Patent Document 3: WO 2010/096359 A1

### SUMMARY OF INVENTION

### Technical Problem

The present inventors found the following problem regarding the cutting of a strengthened glass sheet using internal reforming through laser light.

When a strengthened glass sheet is cut using internal reforming through laser light, depending on usage or the like, there are the cases where the strengthened glass sheet is divided only by forming a reformed region through the irradiation of laser light and the cases where a reformed region is formed by irradiating with laser light and then an external force is applied, thereby dividing the strengthened glass sheet. That is, there are the cases where the strengthened glass sheet is divided only by forming a reformed region without applying any external force and the cases where a reformed region is formed, and then an external force is applied, thereby dividing the strengthened glass sheet.

Both cases can be distinctively used by changing the width of the reformed region in the thickness direction of the strengthened glass sheet. Specifically, when the width of the reformed region is set to be large, the strengthened glass sheet can be divided without applying an external force. On the other hand, when the width of the reformed region is set to be small, the strengthened glass sheet can be divided by applying an external force.

The present inventors found that the critical value of the width of the reformed region situated in the boundary between the case where the strengthened glass sheet is divided without applying an external force and the case where the strengthened glass sheet is divided by applying an external force varies depending on the tensile stress (hereinafter, internal tensile stress) in the intermediate layer of the strengthened glass sheet. In the past, since there was no knowledge of how the critical value of the width of the reformed region varies depending on the internal tensile stress in the strengthened glass sheet, it was difficult to distinctively use the case where the strengthened glass sheet is divided without applying an external force and the case where the strengthened glass sheet is divided by applying an external force.

The present invention has been made in consideration of the above-described problem, and an object of the present invention is to provide a method for cutting a strengthened glass sheet, which is capable of distinctively using in an appropriate manner the case where the strengthened glass sheet is divided without applying an external force and the case where the strengthened glass sheet is divided by applying an external force, in the internal reforming-type cutting.

### Technical Solution

In the first embodiment of the present invention, a method for cutting a strengthened glass sheet including a front surface layer in which a compressive stress remains and a back surface layer in which a compressive stress remains, and an intermediate layer formed between the front surface layer and the back surface layer in which a tensile stress remains, includes:

a step of collecting and scanning laser light in the intermediate layer, thereby forming a first reformed region along a first cutting-scheduled line; and
a step of applying an external force to propagate a crack from the first reformed region as a start point in a thickness direction of the strengthened glass sheet, thereby dividing the strengthened glass sheet,
wherein, in the step of forming the first reformed region,
in a case where a fracture toughness of the strengthened glass sheet is represented by K_{c} (MPa·√m), the tensile stress remaining in the intermediate layer is represented by CT (MPa), and a width of the first reformed region in the thickness direction is represented by d1 (mm), a value of d1 is set to be smaller than 2×10³×K_{c}²/{π×(CT)²}.

In the second embodiment of the present invention, in the method for cutting a strengthened glass sheet according to the first embodiment, in the step of forming the first reformed region, the first reformed region is not formed within a predetermined distance from an edge surface of the strengthened glass sheet.

In the third embodiment of the present invention, in the method for cutting a strengthened glass sheet according to the second embodiment, the predetermined distance is 0.5 mm.

In the forth embodiment of the present invention, the method for cutting a strengthened glass sheet according to any one of the first to third embodiments, further includes:

a step of forming a functional thin film made of an electronic material on at least one main surface of the strengthened glass sheet, after the step of forming the first reformed region and before the step of dividing the strengthened glass sheet.

In the fifth embodiment of the present invention, the method for cutting a strengthened glass sheet according to any one of the first to third embodiments, further inludes:

a step of collecting and scanning laser light in the intermediate layer, thereby forming a second reformed region along a second cutting-scheduled line intersecting the first cutting-scheduled line, and dividing the strengthened glass sheet by propagating a crack from the second reformed region as a start point in the thickness direction of the strengthened glass sheet without applying an external force, after the step of forming the first reformed region and before the step of dividing the strengthened glass sheet,

wherein, when the second reformed region is formed,

in a case where a width of the second reformed region in the thickness direction is represented by d2 (mm), a value of d2 is set to be larger than 2×10³×K_{c}²/{π×(CT)²}.

In the sixth embodiment of the present invention, the method for cutting a strengthened glass sheet according to the fifth embodiment, wherein the second reformed region is formed to a point of an edge surface of the strengthened glass sheet.

In the seventh embodiment of the present invention, a method for cutting a strengthened glass sheet including a front surface layer in which a compressive stress remains and a back surface layer in which a compressive stress remains, and an intermediate layer formed between the front surface layer and the back surface layer in which a tensile stress remains, includes:

a step of collecting and scanning laser light in the intermediate layer, thereby forming a reformed region along a cutting-scheduled line, and dividing the strengthened glass sheet by propagating a crack from the reformed region as a start point in the thickness direction of the strengthened glass sheet without applying an external force,

wherein, when the reformed region is formed,

in a case where a fracture toughness of the strengthened glass sheet is represented by K_{c} (MPa·√m), the tensile stress remaining in the intermediate layer is represented by CT (MPa), and a width of the reformed region of the strengthened glass sheet in the thickness direction is represented by d (mm), a value of d is set to be larger than 2×10³×K_{c}²/{π×(CT)²}.

In the eighth embodiment of the present invention, in the method for cutting a strengthened glass sheet according to the seventh embodiment of the present invention, the reformed region is formed to a point of an edge surface of the strengthened glass sheet.

In the ninth embodiments of the present invention, in the method for cutting a strengthened glass sheet according to any one of the first to eighth embodiments, the strengthened glass sheet is a glass sheet strengthened by a chemical strengthening method.

In the tenth embodiment of the present invention, in the method for cutting a strengthened glass sheet according to the ninth embodiment, a thickness of the strengthened glass sheet is from 0.1 mm to 2 mm.

### Advantageous Effects of Invention

According to the present invention, it is possible to provide a method for cutting a strengthened glass sheet which is capable of distinctively using in an appropriate manner the case where the strengthened glass sheet is divided without applying an external force and the case where the strengthened glass sheet is divided by applying an external force, in internal reforming using laser light.

### BRIEF DESCRIPTION OF DRAWINGS

FIG. 1 is a cross-sectional view of a strengthened glass sheet before irradiation of laser light.

FIG. 2 is a schematic view illustrating the distribution of residual stress in the strengthened glass sheet before irradiation of laser light.

FIG. 3 is a view for explaining a method for cutting a strengthened glass sheet 10, and is a cross-sectional view of a cut surface of the strengthened glass sheet 10.

FIG. 4 is a view for explaining the method for cutting the strengthened glass sheet 10, and is a cross-sectional view of the cut surface of the strengthened glass sheet 10.

FIG. 5 is a cross-sectional view (cross-sectional view seen from a direction perpendicular to the cut surface of the strengthened glass sheet 10) in the direction of the cutting line V-V in FIG. 4.

FIG. 6 illustrates one edge portion of a cut surface in a case where the strengthened glass sheet is divided without applying an external force.

FIG. 7 illustrates one edge portion of a cut surface in a case where the strengthened glass sheet is divided by applying an external force.

FIG. 8 is a view of a top surface (laser light irradiation side) of the strengthened glass sheet 10.

FIG. 9 is a table describing the characteristics values and cutting results of the strengthened glass sheet.

FIG. 10 is a graph illustrating the internal tensile stress CT dependency of a critical width d_{c} of a reformed region.

### DESCRIPTION OF EMBODIMENTS

Hereinafter, specific embodiments to which the present invention is applied will be described in detail with reference to the accompanying drawings, but the present invention is not limited to the following embodiments. In addition, for the clarification of the description, the following description and drawings are appropriately simplified.

### Embodiment 1

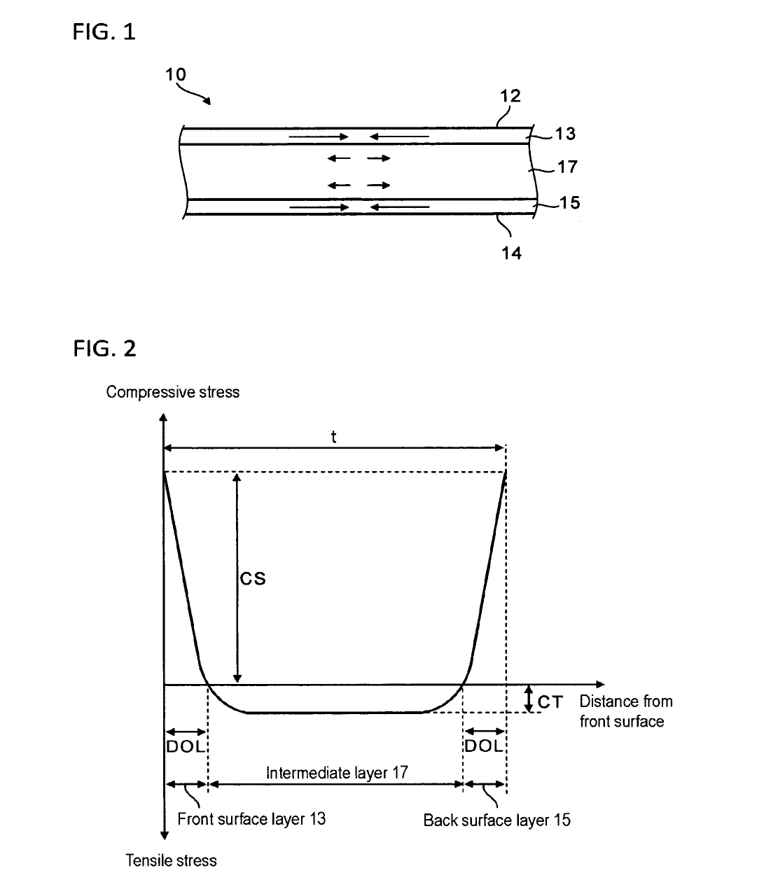

First, the structure of a strengthened glass sheet and a method for cutting a strengthened glass sheet using internal reforming through laser light will be described with reference to FIGS. 1 to 5.

The structure of the strengthened glass sheet will be described with reference to FIGS. 1 and 2. FIG. 1 is a cross-sectional view of a strengthened glass sheet 10 before irradiation of laser light. In FIG. 1, the direction of an arrow indicates an acting direction of a residual stress, and the size of the arrow indicates the intensity of the stress. As illustrated in FIG. 1, the strengthened glass sheet 10 includes a front surface layer 13, a back surface layer 15, and an intermediate layer 17 provided between the front surface layer 13 and the back surface layer 15. In the front surface layer 13 and the back surface layer 15, a compressive stress remains due to the following air-quenching strengthening method or a chemical strengthening method. In addition, as a counteraction thereto, a tensile stress remains in the intermediate layer 17.

The strengthened glass sheet 10 is produced using, for example, the air-quenching strengthening method or the chemical strengthening method. The kind of glass for strengthening is selected depending on the usage thereof. For example, soda-lime glass is used as the glass for strengthening in the case of car window glass, building window glass, a glass substrate for a plasma display panel (PDP), and cover glass.

In the air-quenching strengthening method, glass at a temperature near the softening point is quenched from the front and back surfaces, and a temperature difference is produced between the front and back surfaces of the glass and the inside of the glass, thereby forming a front surface layer in which a compressive stress remains and a back surface layer in which a compressive stress remains. The air-quenching strengthening method is preferred for the strengthening of thick glass.

In the chemical strengthening method, ions are exchanged on the front and back surfaces of a glass, and ions having a small ion radius (for example, Li ions and Na ions) contained in the glass are substituted by ions having a large ion radius (for example, K ions), thereby forming a front surface layer in which a compressive stress remains and a back surface layer in which a compressive stress remains. The chemical strengthening method is preferred for the strengthening of soda-lime glass containing an alkali metal element.

FIG. 2 is a schematic view illustrating the distribution of a residual stress in the strengthened glass sheet 10 before irradiation of laser light.

As illustrated in FIG. 2, the compressive stresses (>0) remaining in the front surface layer 13 and back surface layer 15 tend to gradually decrease from the front surface 12 and back surface 14 toward the inside of the strengthened glass sheet 10. In addition, the tensile stress (>0) remaining in the intermediate layer 17 tends to gradually decrease from the inside toward the front surface 12 and back surface 14 of the glass.

In FIG. 2, CS represents a maximum residual compressive stress (surface compressive stress) (>0) in the front surface layer 13 or back surface layer 15, CT represents an internal tensile stress (an average value of an internal tensile stress in the intermediate layer 17) (>0) in the intermediate layer 17, DOL represents thicknesses of the front surface layer 13 and the back surface layer 15, and t represents a thickness of the strengthened glass sheet 10, respectively. Therefore, the thickness of the intermediate layer 17 is represented by t−2×DOL.

Generally, the internal tensile stress CT of the strengthened glass sheet is determined by measuring the surface compressive stress CS and the thicknesses DOL of the front surface layer 13 and back surface layer 15, and putting the measured values and the thickness t of the strengthened glass sheet into the following formula 1.

CT=(CS×DOL)/(t−2×DOL) Formula 1

The maximum residual compressive stress CS, the internal tensile stress CT, and the thicknesses DOL of the front surface layer 13 and back surface layer 15 can be adjusted under strengthening treatment conditions. For example, in the case of the air-quenching strengthening method, the maximum residual compressive stress CS, the internal tensile stress CT, and the thicknesses DOL of the front surface layer 13 and back surface layer 15 can be adjusted based on the cooling rate and the like of the glass. In addition, in the case of the chemical strengthening method, the maximum residual compressive stress CS, the internal tensile stress CT, and the thicknesses DOL of the front surface layer 13 and back surface layer 15 can be adjusted based on the concentration or temperature of a treatment solution, the immersion time and the like, since ions are exchanged by immersing the glass in the treatment solution (for example, KNO₃ molten salt). The front surface layer 13 and the back surface layer 15 in the present embodiment have the same thickness DOL and the same maximum residual compressive stress CS, but may have different thicknesses or different maximum residual compressive stresses.

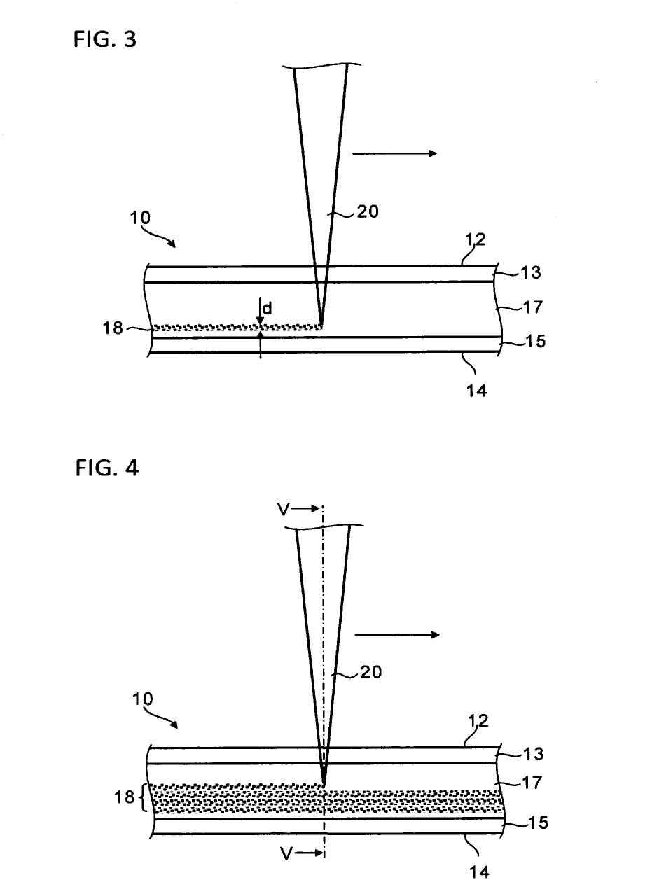

FIG. 3 is a view for explaining a method for cutting the strengthened glass sheet 10, and is a cross-sectional view of a cut surface of the strengthened glass sheet 10. As illustrated in FIG. 3, laser light 20 is scanned in a state in which the laser light 20 is collected in the intermediate layer 17 of the strengthened glass sheet 10. Then, a reformed region 18 is formed in the intermediate layer 17. The reformed region 18 is formed in a band (line) shape having a predetermined width d in the thickness direction of the strengthened glass sheet 10. Hereinafter, the band-shaped reformed region formed by scanning the laser light once will be called a reformed line. That is, the reformed region 18 illustrated in FIG. 3 is constituted by one reformed line.

FIG. 4 is a view for explaining the method for cutting the strengthened glass sheet 10, and is a cross-sectional view of the cut surface of the strengthened glass sheet 10. As illustrated in FIG. 4, in a case where the strengthened glass sheet 10 is cut, generally, the laser light 20 is scanned multiple times. FIG. 4 illustrates an appearance of the fourth scanning of the laser light 20. As illustrated in FIG. 4, the reformed region 18 in which the laser light 20 has been scanned three times is constituted by three reformed lines (the right side in the drawing). Meanwhile, the reformed region 18 in which the laser light 20 has been scanned four times is constituted by four reformed lines (the left side in the drawing).

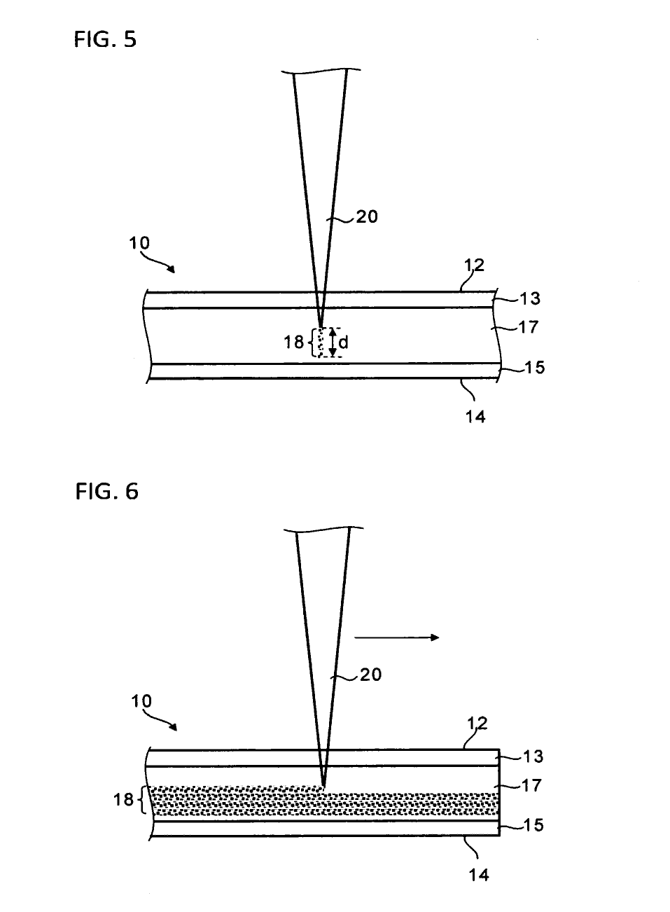

FIG. 5 is a cross-sectional view (cross-sectional view seen from a direction perpendicular to the cut surface of the strengthened glass sheet 10) in the direction of the cutting line V-V in FIG. 4. As illustrated in FIG. 5, the reformed region 18 has almost no thickness in a direction perpendicular to the cut surface.

The reformed region 18 formed by the irradiation of the laser light 20 illustrated in FIGS. 3 to 5 is an internal crack, and the strengthened glass sheet 10 is divided by the propagation in the thickness direction from both edges of the internal crack in the thickness direction of the strengthened glass sheet 10. In a case where the width d of the reformed region 18 in the thickness direction of the strengthened glass sheet 10 is small, the reformed region 18 does not propagate until an external force is applied. On the other hand, when the width d of the reformed region 18 exceeds a critical value d_{c} (hereinafter, referred to as ‘the critical width d_{c} of the reformed region 18), the internal crack propagates from the reformed region 18 as a start point even if no external force is applied.

Generally, in a case where the thickness of an object to be cut is sufficiently larger with respect to the crack length, a critical stress intensity factor, that is, a fracture toughness K_{c} (MPa·√m) is expressed by the following formula 2 when the tensile stress is represented by σₜ (MPa), and the crack length is represented by 2×a_{c} (mm).

K_{c}σₜ×√(10⁻³πa_{c}) Formula 2

Here, when the tensile stress σₜ is assumed as the internal tensile stress CT, the critical crack length 2×a_{c} can be expressed by the following formula 3.

2×a_{c}=2×10³×K_{c}²/{π×(CT)²} Formula 3

In detail, as described below in Examples, the present inventors experimentally found that the critical crack length 2×a_{c} determined from Formula 3 almost corresponds to the critical width d_{c} of the reformed region 18. Then, it is possible to distinctively use in an appropriate manner the case where the strengthened glass sheet is divided without applying an external force and the case where the strengthened glass sheet is divided by applying an external force. That is, in a case where the strengthened glass sheet is divided without applying an external force, the width of the reformed region 18 formed by the irradiation of laser light is set to be larger than the critical crack length 2×a_{c} determined from Formula 3. On the other hand, in a case where the strengthened glass sheet is divided by applying an external force, the width of the reformed region 18 formed by the irradiation of laser light is set to be smaller than the critical crack length 2×a_{c} determined from Formula 3.

FIG. 6 illustrates one edge portion of a cut surface in a case where the strengthened glass sheet is divided without applying an external force. As illustrated in FIG. 6, the reformed region 18 is formed to a point of the edge surface of the strengthened glass sheet 10 intersecting the cut surface. That is, the reformed region 18 is formed so as to penetrate the strengthened glass sheet from one edge surface to the other edge surface.

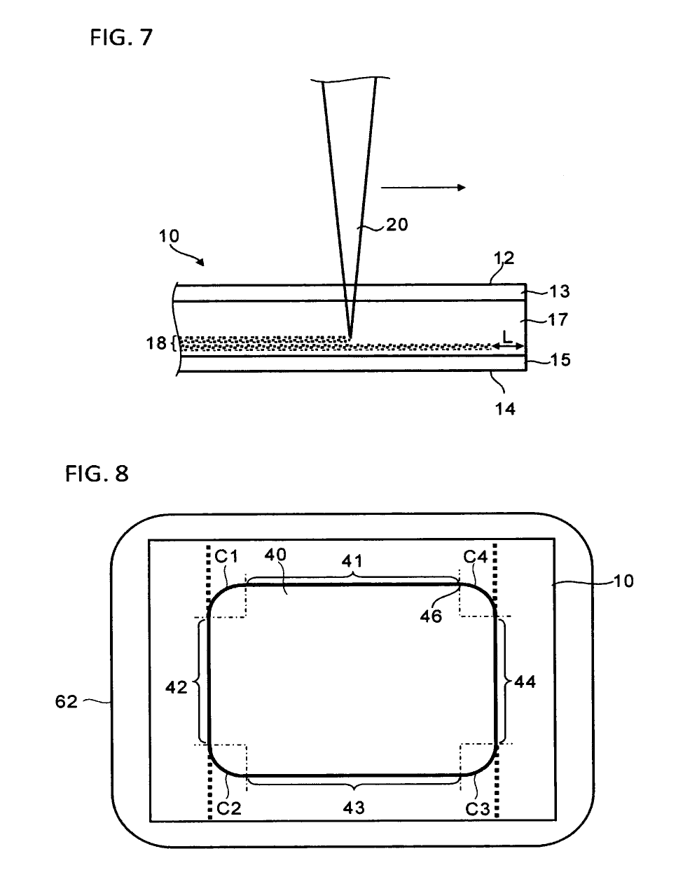

FIG. 7 illustrates one edge portion of a cut surface in a case where the strengthened glass sheet is divided by applying an external force. As illustrated in FIG. 7, the reformed region 18 is not formed to a point of the edge surface of the strengthened glass sheet 10 intersecting the cut surface. Specifically, the reformed region 18 is formed so that a predetermined interval L is formed between the front edge of the reformed region 18 in the lengthwise direction and the edge surface of the strengthened glass sheet 10. This is to prevent the intrusion of moisture into the reformed region 18 from the edge surface of the strengthened glass sheet 10. This is because, when the reformed region 18 turns into an opening crack, and a small amount of moisture in the atmosphere or the like intrudes, the internal crack is likely to propagate, and there is a concern that the strengthened glass sheet 10 may be unintentionally divided within a short time.

That is, when the strengthened glass sheet includes an opening crack, the influence of moisture makes it difficult to control the propagation of the crack by regulating the width of the reformed region 18. Specifically, even when the width of the reformed region 18 was set to be smaller than the critical crack length 2×a_{c} determined from Formula 3, there was a concern that the crack might propagate, and the strengthened glass sheet might be divided. In the internal reforming-type cutting method, as described above, the strengthened glass sheet can be cut without forming an opening crack, and therefore it is possible to effectively control the propagation of the crack by regulating the width of the reformed region 18. It is difficult to cut the strengthened glass sheet without forming an opening crack using a cutting method other than the internal reforming-type method.

In a case where the strengthened glass sheet 10 is divided by applying an external force, it is possible to divide the strengthened glass sheet by, for example, forming the reformed region 18 by the irradiation of laser light, then, forming a functional thin film made of an electronic material on at least one main surface of the strengthened glass sheet 10, and subsequently, applying an external force. Examples of the functional thin film made of an electronic material include a transparent conductive film, a metal wire, and the like. Instead of or in addition to the functional thin film made of an electronic material, other functional thin films such as an anti-fingerprint film, an anti-reflection film, an anti-scattering film, an antistatic film, and a light-shielding film may be formed. The thickness of the functional thin film is not particularly limited, and is, for example, 0.5 μm to 100 μm.

In the above-described case, it is possible to form the functional thin film to a point of the cut edge surface. Meanwhile, in a case where the functional thin film is formed, and then the strengthened glass sheet is divided without applying an external force, it is necessary to remove the functional thin film in a laser irradiation part after a mask treatment or the like is performed. Therefore, the number of steps increases, and it is not possible to form the functional thin film to a point of the cut edge surface. In the present specification, the “main surface” refers to the front surface layer and the back surface layer.

In a case where, for example, a large-size strengthened glass sheet is cut in the vertical and horizontal directions, and a strip-shape strengthened glass sheet is cut out, it is possible to, first, form the reformed region 18 of the case where the strengthened glass sheet is divided by applying an external force in a first direction, and then form the reformed region 18 of the case where the strengthened glass sheet is divided without applying an external force in a second direction. That is, it is also possible to divide the strengthened glass sheet in the second direction in which laser has been irradiated after the irradiation in the first direction by irradiation of laser light, and then divide the strengthened glass sheet by applying an external force in the first direction in which laser has been irradiated before the irradiation in the second direction. Then, the productivity is improved as compared with a case in which the strengthened glass sheet is divided without applying an external force in both the vertical and horizontal directions. In addition, handling becomes easy as compared with a case in which the strengthened glass sheet is divided by applying an external force in both the vertical and horizontal directions.

The laser light 20 is scanned at a rate depending on the thickness of the strengthened glass sheet 10, the maximum residual compressive stress CS, the internal tensile stress CT, the thicknesses DOL of the front surface layer 13 and the back surface layer 15, the output of a light source of the laser light 20, and the like.

As the laser light 20, laser light having a wavelength that penetrates strengthened glass (ultraviolet region to infrared region) is used. As an oscillation method of the laser light 20, a pulse oscillation method is desirable.

The wavelength of the laser light 20 is preferably 200 nm to 2000 nm. When the wavelength of the laser light 20 is 200 nm to 2000 nm, it is possible to satisfy both the transmittance of the laser light 20 and the heating efficiency through the laser light 20. The wavelength of the laser light 20 is more preferably 532 nm to 2000 nm, and still more preferably 532 nm to 1100 nm.

The thickness t of the strengthened glass sheet 10 is set depending on usage thereof, and is preferably 0.1 mm to 2 mm. In the case of the chemically strengthened glass, when the thickness t is 2 mm or less, the internal tensile stress CT can be sufficiently increased. On the other hand, when the thickness t is less than 0.1 mm, it is difficult to subject a glass to a chemical strengthening treatment. The thickness t is preferably 0.3 mm to 1.5 mm, and still more preferably 0.5 mm to 1.5 mm.

Furthermore, a method for cutting out a strengthened glass panel from the strengthened glass sheet will be described with reference to FIG. 8. FIG. 8 is a view of a top surface (laser light irradiation side) of the strengthened glass sheet 10.

The heavy line illustrated inside the strengthened glass sheet 10 indicates a cutting-scheduled line 35 for cutting out a strengthened glass panel 40 from the strengthened glass sheet 10 using the above-described cutting method.

In addition, the dotted line illustrated inside the strengthened glass sheet 10 indicates a glass holding unit (adsorption table) 62 that holds the glass sheet 10. As the glass holding unit 62, a vacuum adsorption table can be used. Since the energy of the laser light being irradiated is almost entirely consumed for the formation of the reformed region, the glass holding unit 62 may be positioned at the laser light irradiation position as illustrated in FIG. 8. Therefore, the entire strengthened glass sheet 10 can be supported by the glass holding unit 62.

The strengthened glass panel 40 has a rectangular shape having four corner sections C1, C2, C3, and C4, which have a predetermined curvature radius R, and straight sections 41, 42, 43, and 44. The shape of the strengthened glass panel 40 illustrated in FIG. 8 is an example, and the method for cutting strengthened glass according to the present embodiment can be used even in a case where the strengthened glass panel 40 having another arbitrary shape is cut out from the strengthened glass sheet 10.

When the strengthened glass panel 40 is cut out from the strengthened glass sheet 10, it is not necessary to scan the laser light from the edge of the glass. For example, the laser light is scanned so as to start from a position 46, which is a connection point between the corner section C4 and the straight section 41, pass through the straight section 41, the corner section C1, the straight section 42, the corner section C2, the straight section 43, the corner section C3, the straight section 44, and the corner section C4, and then come back to the position 46. The scanning start position (that is, the scanning end position) is not limited to the position 46, and can be set to an arbitrary position on the cutting-scheduled line.

When the strengthened glass panel 40 is cut out from the strengthened glass sheet 10, it is preferable to divide the strengthened glass sheet without applying an external force. Therefore, the width of the reformed region 18 formed by the irradiation of the laser light is set to be larger than the critical crack length 2×a_{c} determined from Formula 3. In order to achieve this, it is necessary to repeat the scanning of the laser light. At this time, it is possible to carry out each scanning in a horizontal surface, and raise the scanning position whenever the laser light comes back to the scanning start position. However, it is necessary to pause the scanning whenever the scanning position is raised, and therefore the productivity is decreased. Therefore, it is more preferable to continuously scan the laser light while the scanning position is gradually raised (that is, in a spiral manner) little by little.

After the strengthened glass panel 40 is cut out, the laser light is scanned on predetermined positions (for example, four dotted lines illustrated in FIG. 8) in an unnecessary portion positioned outside the strengthened glass panel 40, whereby the unnecessary portion is split, and the strengthened glass panel 40 is taken out.

### EXAMPLES

Hereinafter, specific examples of the present invention will be described. In Example 1, the relationship between the internal tensile stress CT and the critical width d_{c} of the reformed region 18 will be described.

### Example 1

In Example 1, the scanning of laser light irradiation was repeated on seven kinds of chemically strengthened glass sheet samples until the samples were divided, and the widths of the reformed regions at the time of the samples being divided were measured as the critical widths d_{c} of the reformed regions.

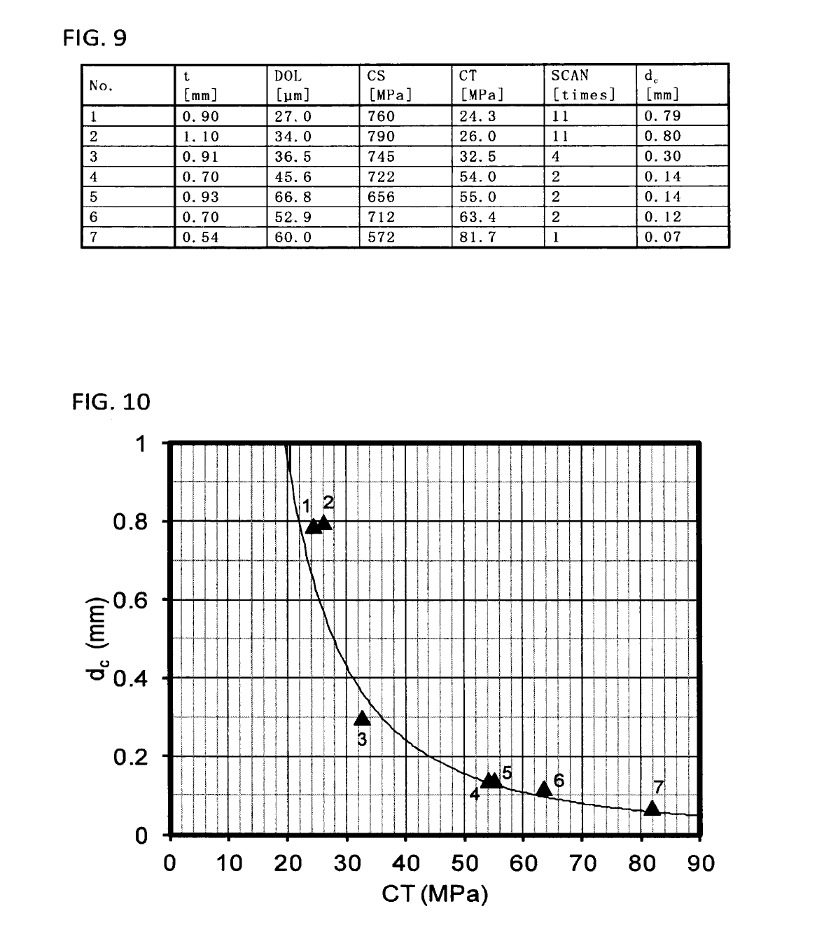

FIG. 9 is a table describing the characteristics values and cutting results of the strengthened glass sheet. Specifically, from the left column, the table sequentially describes sample numbers, the thicknesses t (mm) of the strengthened glass sheets, the thicknesses DOL (mm) of the front surface layers and the back surface layers, the surface compressive stresses CS (MPa), the internal tensile stresses CT (MPa), the number of times of the scanning (SCAN TIMES), and the critical widths d_{c} (mm) of the reformed regions.

The internal tensile stress CT of the strengthened glass sheet was measured by measuring the surface compressive stress CS and the thicknesses DOL of the compressive stress layers (the front surface layer and the back surface layer) using a surface stress meter FSM-6000 (manufactured by Orihara Manufacturing Co., Ltd.), and putting the measured values and the thickness t of the strengthened glass sheet into the following formula 1.

CT=(CS×DOL)/(t−2×DOL) Formula 1

While not illustrated in FIG. 9, a Nd:YAG pulse laser (central wavelength band: 532 nm, repetition frequency: 15 kHz, pulse width: 600 ps) was used as a light source of the laser light for all the samples. In addition, the beam diameter at the light concentration point of the laser light was set to 1 μm, the output of the laser light was set to 15 μ, and the scanning rate of the laser light was set to 150 mm/s.

Next, the critical width d_{c} of the reformed region will be described. As illustrated in FIG. 9, the critical width d_{c} of the reformed region abruptly decreased as the internal tensile stress CT increased.

FIG. 10 is a graph illustrating the internal tensile stress CT dependency of the critical width d_{c} of the reformed region. In FIG. 10, the horizontal axis indicates the internal tensile stress CT (MPa), and the vertical axis indicates the critical width dₑ (mm) of the reformed region. In FIG. 10, the data points of Samples No. 1 to 7 are indicated using triangular points. In addition, the curve indicates the critical crack length 2×a_{c} determined from the above-described Formula 3 which will be described below as the critical width d_{c} of the reformed region.

2×a_{c}=2×10³×K_{c}²/{π×(CT)²} Formula 3

In each of all the samples, the fracture toughness K_{c} was 0.78 MPa·√m. The fracture toughness K_{c} was measured using the Chevron notched beam method (for example, refer to pp. 137 to 141, Int. J. Fracture, 16 (1980)). That is, a Chevron-type notch was formed in the central portion of a test specimen having a thickness of 8 mm, a width of 8 mm, and a length of 80 mm. A four-point bending test was carried out at a crosshead rate of 0.005 mm/minute using a Tensilon-type strength tester so that stable fractures occurred from the notch tips of the test specimens supported at a span of 64 mm. The top span was set to 16 mm. The measurement was carried out in a dry N₂ atmosphere to avoid the fatigue effect in glass arising from moisture.

As illustrated in FIG. 10, the critical crack length 2×a_{c} (the curve in FIG. 10) determined from Formula 3, in which the internal tensile stress CT was used as the tensile stress, almost corresponds to the critical width d_{c} (the triangular point in FIG. 10) of the reformed region 18. Thus, it is possible to distinctively use in an appropriate manner the case where the strengthened glass sheet is divided without applying an external force and the case where the strengthened glass sheet is divided by applying an external force. That is, it was found that, in a case where the strengthened glass sheet is divided without applying an external force, it is necessary to set the width of the reformed region 18 formed by the irradiation of laser light to be larger than the critical crack length 2×a_{c}=2×10³×K_{c}²/{π×(CT)²} determined from Formula 3. On the other hand, it was found that, in a case where the strengthened glass sheet is divided by applying an external force, it is necessary to set the width of the reformed region 18 formed by the irradiation of laser light to be smaller than the critical crack length 2×a_{c}=2×10³×K_{c}²/{π×(CT)²} determined from Formula 3.

As described above, the actually-measured critical width d_{c} of the reformed region 18 extremely closely matched the critical crack length 2×a_{c} determined from Formula 3. That is, it was found that, in Formulae 2 and 3, it is not necessary to take the presence of the front surface layer 13 and the back surface layer 15 in which the compressive stress remains into account.

Thus far, the present invention has been descried using the above-described embodiment, but the present invention is not limited to the constitution of the above-described embodiment, and it is needless to say that the present invention includes a variety of modifications, corrections, and combinations that could have been easily attained by those skilled in the art within the scope of the invention.

This application is based on Japanese Patent application No. 2012-121508 filed on May 29, 2012, the contents of which are incorporated herein by reference.

### INDUSTRIAL APPLICABILITY

According to the method for cutting a strengthened glass sheet in the present invention, it is possible to distinctively use in an appropriate manner the case where the strengthened glass sheet is divided without applying an external force and the case where the strengthened glass sheet is divided by applying an external force, in internal reforming using laser light.

### REFERENCE SIGNS LIST

10 Strengthened glass sheet

12 Front surface

13 Front surface layer

14 Back surface

15 Back surface layer

17 Intermediate layer

18 Reformed region

20 Laser light

35 Cutting-scheduled line

40 Strengthened glass panel

41, 42, 43, 44 Straight section

46 Position

62 Glass holding unit

C1, C2, C3, C4 Corner section

1. A method for cutting a strengthened glass sheet comprising a front surface layer in which a compressive stress remains and a back surface layer in which a compressive stress remains, and an intermediate layer formed between the front surface layer and the back surface layer in which a tensile stress remains, the method comprising:
a step of collecting and scanning laser light in the intermediate layer, thereby forming a first reformed region along a first cutting-scheduled line; and
a step of applying an external force to propagate a crack from the first reformed region as a start point in a thickness direction of the strengthened glass sheet, thereby dividing the strengthened glass sheet,
wherein, in the step of forming the first reformed region,
in a case where a fracture toughness of the strengthened glass sheet is represented by K_{c} (MPa·√m), the tensile stress remaining in the intermediate layer is represented by CT (MPa), and a width of the first reformed region in the thickness direction is represented by d1 (mm), a value of d1 is set to be smaller than 2×10³×K_{c}²/{π×(CT)²}.

2. The method for cutting a strengthened glass sheet according to claim 1, wherein, in the step of forming the first reformed region, the first reformed region is not formed within a predetermined distance from an edge surface of the strengthened glass sheet.

3. The method for cutting a strengthened glass sheet according to claim 2, wherein the predetermined distance is 0.5 mm.

4. The method for cutting a strengthened glass sheet according to claim 1, further comprising:
a step of forming a functional thin film made of an electronic material on at least one main surface of the strengthened glass sheet, after the step of forming the first reformed region and before the step of dividing the strengthened glass sheet.

5. The method for cutting a strengthened glass sheet according to claim 1, further comprising:
a step of collecting and scanning laser light in the intermediate layer, thereby forming a second reformed region along a second cutting-scheduled line intersecting the first cutting-scheduled line, and dividing the strengthened glass sheet by propagating a crack from the second reformed region as a start point in the thickness direction of the strengthened glass sheet without applying an external force, after the step of forming the first reformed region and before the step of dividing the strengthened glass sheet,
wherein, when the second reformed region is formed,
in a case where a width of the second reformed region in the thickness direction is represented by d2 (mm), a value of d2 is set to be larger than 2×10³×K_{c}²/{π×(CT)²}.

6. The method for cutting a strengthened glass sheet according to claim 5, wherein the second reformed region is formed to a point of an edge surface of the strengthened glass sheet.

7. A method for cutting a strengthened glass sheet comprising a front surface layer in which a compressive stress remains and a back surface layer in which a compressive stress remains, and an intermediate layer formed between the front surface layer and the back surface layer in which a tensile stress remains, the method comprising:
a step of collecting and scanning laser light in the intermediate layer, thereby forming a reformed region along a cutting-scheduled line, and dividing the strengthened glass sheet by propagating a crack from the reformed region as a start point in the thickness direction of the strengthened glass sheet without applying an external force,
wherein, when the reformed region is formed,
in a case where a fracture toughness of the strengthened glass sheet is represented by K_{c} (MPa·√m), the tensile stress remaining in the intermediate layer is represented by CT (MPa), and a width of the reformed region of the strengthened glass sheet in the thickness direction is represented by d (mm), a value of d is set to be larger 2×10³×K_{c}²/{π×(CT)²}.

8. The method for cutting a strengthened glass sheet according to claim 7, wherein the reformed region is formed to a point of an edge surface of the strengthened glass sheet.

9. The method for cutting a strengthened glass sheet according to claim 1, wherein the strengthened glass sheet is a glass sheet strengthened by a chemical strengthening method.

10. The method for cutting a strengthened glass sheet according to claim 9, wherein a thickness of the strengthened glass sheet is from 0.1 mm to 2 mm.

11. The method for cutting a strengthened glass sheet according to claim 7, wherein the strengthened glass sheet is a glass sheet strengthened by a chemical strengthening method.

12. The method for cutting a strengthened glass sheet according to claim 11, wherein a thickness of the strengthened glass sheet is from 0.1 mm to 2 mm.
